(19) United States
(12) Patent Application Publication
(10) Pub. No.: US 2026/0245102 A1
(43) Pub. Date: Aug. 20, 2026

(54) LOTTERY TICKET SELLING SYSTEMS AND METHODS OF OPERATION THEREOF THAT EMPLOY TICKET PURCHASE IDENTIFIERS FOR DRAW LOTTERY TICKETS

(71) Applicant: Brightstar Global Solutions Corporation, Providence, RI (US)

(72) Inventor: Paul Schneider, Jerome, ID (US)

(21) Appl. No.: 19/058,489

(22) Filed: Feb. 20, 2025

(51) Int. Cl. G06Q 30/018; A63F 3/06; G06Q 20/20; G06Q 50/34; G07F 17/32

(52) U.S. Cl. CPC G06Q 30/0185; A63F 3/0655; G06Q 20/208; G06Q 50/34; G07F 17/329

(57) ABSTRACT

Lottery ticket selling systems and methods of operating the systems that enable the purchase of a draw lottery ticket using a ticket purchase identifier, wherein the system includes an electronic ticket retail server, an electronic bet details display device, and a lottery terminal.

### BACKGROUND

The present disclosure relates to lottery ticket selling systems that employ ticket purchase identifiers for draw lottery tickets.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to lottery ticket selling systems that employ ticket purchase identifiers for draw lottery tickets.

In various embodiments, the present disclosure relates to a lottery ticket selling system comprising, an electronic bet details display device, a lottery terminal associated with a code reader and a lottery ticket printer, the lottery terminal comprising a terminal processor and a terminal memory device that stores a first plurality of instructions, and an electronic ticket retail server comprising a server processor and a server memory device that stores a second plurality of instructions. The second plurality of instructions, when executed by the server processor, cause the server processor to: receive an order from a player electronic device associated with an original purchaser, the order comprising bet details for a purchase of a draw lottery ticket; generate a ticket purchase identifier for the draw lottery ticket prior to the purchase of the draw lottery ticket, wherein the original purchaser is uniquely identifiable using the ticket purchase identifier; generate a digital bet slip that comprises the bet details for the draw lottery ticket and the ticket purchase identifier; and send the digital bet slip to the electronic bet details display device such that the electronic bet details display device receives and displays the digital bet slip. The first plurality of instructions, when executed by the terminal processor, cause the terminal processor to: employ the code reader to scan the displayed digital bet slip to obtain scanned bet slip data; cause the purchase of the draw lottery ticket based on the scanned bet slip data; and cause the lottery ticket printer to print the purchased draw lottery ticket, the printed draw lottery ticket comprising ticket details and the ticket purchase identifier.

In various other embodiments, the present disclosure relates to a lottery ticket selling system comprising an electronic bet details display device comprising a display device and a ticket code reader, a lottery terminal associated with a terminal code reader and a lottery ticket printer, the lottery terminal comprising a terminal processor and a terminal memory device that stores a first plurality of instructions, and an electronic ticket retail server comprising a server processor and a server memory device that stores a second plurality of instructions. The plurality of second instructions, when executed by the server processor, cause the server processor to: receive an order comprising bet details for a purchase of a draw lottery ticket for an original purchaser; generate a ticket purchase identifier for the draw lottery ticket prior to the purchase of the draw lottery ticket, wherein the original purchaser is uniquely identifiable using the ticket purchase identifier; generate a digital bet slip that comprises the bet details for the draw lottery ticket and the ticket purchase identifier; and send the digital bet slip to the electronic bet details display device such that the electronic bet details display device receives and displays the digital bet slip via the display device. The first plurality of instructions, when executed by the terminal processor, cause the terminal processor to: employ the terminal code reader to scan the displayed digital bet slip to obtain scanned bet slip data; cause the purchase of the draw lottery ticket based on the scanned bet slip data; and cause the lottery ticket printer to print the purchased draw lottery ticket, the printed draw lottery ticket comprising ticket details and the ticket purchase identifier. Additionally, the electronic bet details display device employs the ticket code reader to scan the printed draw lottery ticket to obtain scanned draw lottery ticket data and sends the scanned draw lottery ticket data to the electronic ticket retail server.

In various other embodiments, the present disclosure relates to a lottery ticket selling system comprising a lottery central system comprising a central system processor and a central system memory device that stores a first plurality of instructions, and a lottery terminal associated with a code reader and a lottery ticket printer, the lottery terminal comprising a terminal processor and a terminal memory device that stores a second plurality of instructions. The plurality of second instructions, when executed by the terminal processor, cause the terminal processor to: employ the code reader to scan a bet slip to obtain scanned bet slip data, the bet slip comprising bet details for a purchase of a draw lottery ticket and a ticket purchase identifier for the draw lottery ticket, wherein an original purchaser of the draw lottery ticket is uniquely identifiable using the ticket purchase identifier; generate a bet request based on the scanned bet slip data, the bet request comprising the ticket purchase identifier and the bet details; and send the bet request to the lottery central system to cause the purchase of the draw lottery ticket. The first plurality of instructions, when executed by the central system processor, cause the central system processor to: receive the bet request from the lottery terminal; generate a bet comprising ticket details for a purchased draw lottery ticket based on the bet request; log the bet and the ticket purchase identifier for the purchased draw lottery ticket; and generate a bet response comprising the ticket details and the ticket purchase identifier; and send the bet response to the lottery terminal. Additionally, the second plurality of instructions, when executed by the terminal processor, cause the terminal processor to: receive the bet response from the lottery central system; and cause the lottery ticket printer to print the purchased draw lottery ticket, the printed draw lottery ticket comprising the ticket purchase identifier and the ticket details.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a known lottery ticket selling system, showing a courier server that employs a bet slip to enable a purchase of a draw lottery ticket such as the draw lottery ticket of FIG. 1.

FIG. 3A is a diagrammatic view of an example lottery ticket selling system that includes an electronic ticket retail server employing a digital bet slip that enables identification of an original purchaser of a draw lottery ticket in accordance with one example embodiment of the present disclosure.

FIG. 3B is a perspective view of the example lottery ticket selling system of FIG. 3A, diagrammatically showing the electronic ticket retail server causing a display of a digital bet slip quick response (QR) code in accordance with one example embodiment of the present disclosure.

FIG. 4 is front view of an example draw lottery ticket that includes a ticket QR code that includes the ticket purchase identifier in accordance with one example embodiment of the present disclosure.

FIG. 5 is a flow diagram showing one example method of operation of the lottery ticket selling system of FIG. 3A for a draw lottery ticket purchase by an original purchaser in accordance with one example embodiment of the present disclosure.

### DETAILED DESCRIPTION

In various embodiments, the present disclosure relates generally to lottery ticket selling systems and methods of operating the lottery ticket selling systems, wherein the lottery ticket selling systems include an electronic ticket retail server (such as a courier server) that generates a courier string or other suitable ticket purchase identifier employable to associate a draw lottery ticket with an original purchaser of that draw lottery ticket. The electronic ticket retail server generates the ticket purchase identifier for the draw lottery ticket prior to a purchase of that draw lottery ticket.

In various embodiments, the lottery ticket selling system includes: (a) a player electronic device with a mobile application downloaded thereon; (b) an electronic ticket retail server; (c) an electronic bet details display device; (d) a lottery terminal; (e) a lottery central system; (f) a lottery ticket printer; and (g) a lottery ticket scanner.

In various other embodiments, the lottery ticket selling system includes: (a) an electronic ticket retail server; (b) an electronic bet details display device; (c) a lottery terminal; (d) a lottery central system; (e) a lottery ticket printer; and (f) a lottery ticket scanner, wherein the electronic ticket retail server is configured to communicate with each of a plurality of player electronic devices.

In various other embodiments, the lottery ticket selling system includes: (a) an electronic ticket retail server; (b) an electronic bet details display device; (c) a lottery terminal; (d) a lottery central system; and (e) a lottery ticket printer, wherein the electronic ticket retail server is configured to communicate with each of a plurality of player electronic devices.

In various other embodiments, the lottery ticket selling system includes: (a) an electronic ticket retail server; (b) an electronic bet details display device; (c) a lottery terminal; and (d) a lottery ticket printer, wherein the electronic ticket retail server is configured to communicate with each of a plurality of player electronic devices and wherein the lottery terminal is configured to communicate with a lottery central system.

In various embodiments, the lottery ticket selling system enables: (1) an original purchaser to employ a player electronic device to cause a purchase of a draw lottery ticket without visiting a lottery terminal at a retail location; and (2) prior to the purchase of the draw lottery ticket, generation of a courier string or other suitable ticket purchase identifier that is employable to associate the purchased draw lottery ticket with the original purchaser.

In various other embodiments, the lottery ticket selling system enables: (1) an original purchaser to employ a player electronic device to cause a purchase of a draw lottery ticket without visiting a lottery terminal at a retail location; (2) prior to the purchase of the draw lottery ticket, generation of a courier string or other suitable ticket purchase identifier employable to associate the purchased draw lottery ticket with the original purchaser; (3) purchase of the draw lottery ticket; and (4) printing of the purchased draw lottery ticket, wherein the printed draw lottery ticket includes the ticket purchase identifier.

In various other embodiments, the lottery ticket selling system enables: (1) an original purchaser to employ a player electronic device to cause a purchase of a draw lottery ticket without visiting a lottery terminal at a retail location; (2) prior to the purchase of the draw lottery ticket, generation of a courier string or other suitable ticket purchase identifier employable to associate the purchased draw lottery ticket with the original purchaser; (3) purchase of the draw lottery ticket; and (4) storing of the ticket purchase identifier by a lottery central system for the draw lottery ticket.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

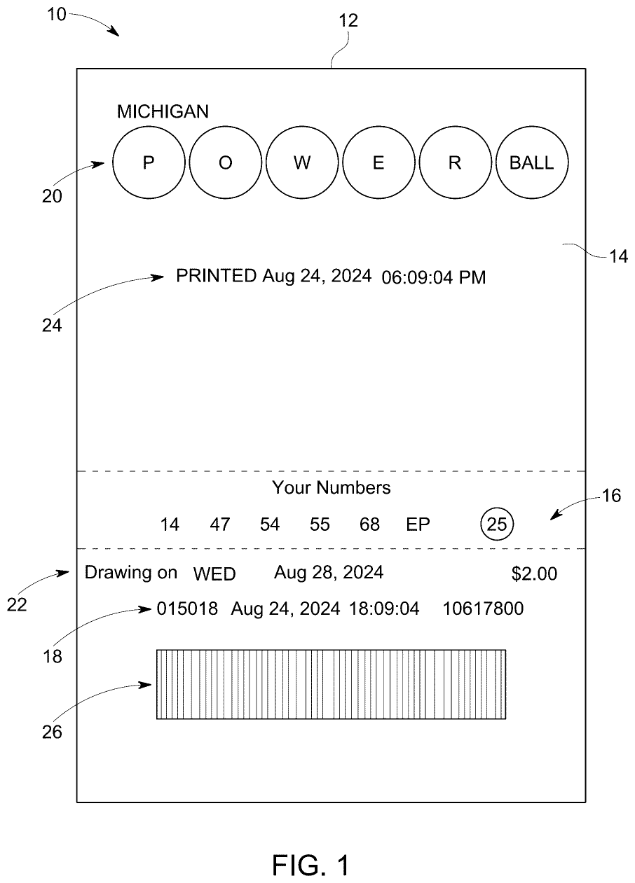

An example physical draw lottery ticket 10 is shown in FIG. 1. This example draw lottery ticket includes: (1) a ticket substrate 12; (2) a front surface 14 of the ticket substrate 12; (3) lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Wednesday Aug. 28, 2024) and includes a single set of player numbers 16 (i.e., player numbers for the single play of the draw lottery game). The lottery ticket information in this example includes player numbers 16, a ticket identifier 18 that uniquely identifies the lottery ticket 10, a game identifier 20 that identifies the lottery game type, a draw date 22 associated with the ticket 10, and a print date 24 on which the ticket 10 was printed. It should be appreciated that while this draw lottery ticket is for a single play, draw lottery tickets often include multiple sets of player numbers that are for a single play of the draw lottery game. The lottery ticket information can include text, one or more ticket numbers (shown as the ticket identifier 18), one or more ticket barcodes (shown as barcode 26), and other lottery ticket information that is in either or both human readable and machine-readable forms. The lottery ticket's barcode 26 is configured to be scanned by a barcode reading device to enable redemption of such draw lottery ticket.

Additionally, for a better understanding of the present disclosure, an example known system and method employed for purchasing draw lottery tickets is also now described.

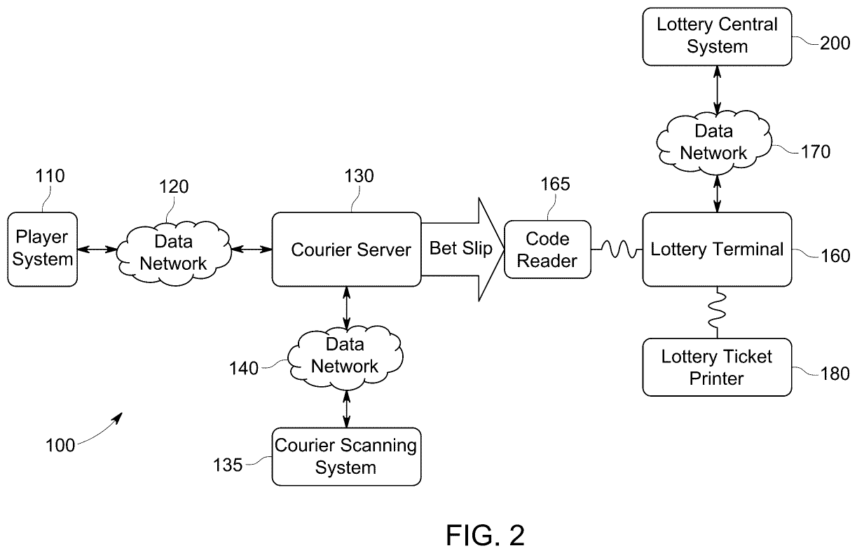

Various jurisdictions (such as various states) do not permit remote or electronic purchase of draw lottery tickets, and in various such jurisdictions, an example known lottery ticket system using a courier service has been employed. Turning to FIG. 2, an example known courier system 100 (or “system 100”) includes: (a) a player system 110 with a courier mobile application downloaded thereon; (b) a courier server 130; (c) a courier scanning system 135; (d) a lottery terminal 160; (e) a barcode reader 165 associated with the lottery terminal 160; (f) a lottery ticket printer 180; and (g) a lottery central system 200.

The player system 110 and the courier server 130 are configured to communicate with each other via a data network 120. The courier server 130 and the courier scanning system 135 are configured to communicate with each other via a data network 140. The lottery terminal 160 and the barcode reader 165 are configured to communicate with each other via hard wire such as an USB connector. The lottery terminal 160 and the lottery ticket printer 180 are configured to communicate with each other via hard wire such as an USB connector. The lottery terminal 160 and the lottery central system 200 are configured to communicate with each other via a data network.

The player system 110 includes a player electronic device, such as a smartphone with the courier mobile application downloaded thereon. The player system 110 is employable by an original purchaser (also sometimes referred to herein as a “player”) to purchase a draw lottery ticket.

The courier server 130 includes a server configured to receive bet details from the player system 110 via the courier mobile application and to generate a suitable bet slip for the draw lottery game based on the bet details. The bet slip includes lottery ticket information, such as a player's selected numbers or quick pick numbers for a selected play of a selected draw lottery game. The bet slip(s) are provided to the lottery terminal 160 for printing of draw lottery tickets.

The courier scanning system 135 includes an image capture device configured to scan a printed draw lottery ticket to obtain scanned ticket image data. The courier scanning system 135 provides the scanned ticket image data to the courier server 130.

The lottery terminal 160 enables an original purchaser and/or operator of the lottery terminal 160 to use such components to input lottery ticket purchase data for selecting and paying for draw lottery tickets that the original purchaser desires to obtain. That is, the lottery terminal 160 generates the lottery ticket information for the lottery ticket based on user inputs (e.g., bet details) from the original purchaser and/or operator of the lottery terminal 160 via the purchaser interface components.

The lottery ticket printer 180 is configured to receive lottery ticket printing data from the lottery terminal 160 and print a physical lottery ticket based on the lottery ticket printing data.

The lottery central system 200 includes a server configured to provide draw lottery games and to facilitate the purchase, validation, and redemption of draw lottery tickets for such draw lottery games.

The courier system 100 has been used to enable players to remotely electronically purchase draw lottery tickets for draw lottery games wherein the courier service conducts various physical steps of the lottery ticket purchase process on behalf of the players. More specifically, this known system enables a purchase of a draw lottery ticket for a draw lottery game remotely. A player uses the player system 110 (such as an application on their smartphone) to purchase a draw lottery ticket (which can include the player inputting the player's selected numbers or a quick pick indication for the draw lottery game). This application is referred to as a courier mobile application.

The courier mobile application functions to create bet details (including the player's selected numbers, quick pick numbers that the courier mobile application randomly selected, or a quick pick indication for a lottery terminal to randomly select the quick pick numbers) and causes the player's smartphone to send the bet details via the data network 120 to the courier server 130 at a courier processing center. The courier server 130 uses the received bet details to create and cause a courier printer (not shown) to physically print a physical paper bet slip for the play of the draw lottery game at the courier processing center. The bet slip includes the bet details, such as the player numbers or the quick pick indication.

A human courier processing clerk takes the printed paper bet slip for the play of the draw lottery game to an operator of the lottery terminal 160 at a physical location of the lottery terminal 160 that is remote from the courier processing center. The operator uses the barcode reader 165 associated with the lottery terminal 160 to scan the printed paper bet slip. The barcode reader 165 creates bet slip scan data for the draw lottery ticket, and a terminal application of the lottery terminal 160 uses that bet slip scan data to determine the player numbers for the play of the draw lottery game and to create the lottery ticket. The lottery terminal 160 causes the lottery ticket printer 180 to print out the draw lottery ticket with the player numbers. The operator of the lottery terminal 160 also collects the payment for the draw lottery ticket from the courier processing clerk and provides the printed draw lottery ticket to the courier processing clerk. The courier processing clerk then takes the printed bet slip and the printed draw lottery ticket back to the courier processing center.

The courier processing clerk scans the printed draw lottery ticket using the courier scanning system 135 connected to the courier server 130. The courier server 130 links the scanned draw lottery ticket back to a player account established through the courier mobile application. The courier server 130 then makes the scanned lottery ticket available for the player to view via the courier mobile application on the player system 110. The courier processing clerk places the printed bet slip and the printed draw lottery ticket in secure courier storage locations for storage if needed at a later time.

After the draw for the play of the draw lottery game takes place, if the player's lottery ticket is a winning lottery ticket and the winning amount is less than $600, the courier server automatically credits the winning amount for the player's draw lottery ticket to the player's account. The courier service can then retrieve and redeem the stored actual winning printed draw lottery ticket at a location having a lottery terminal. After the draw for the draw lottery game takes place, if the player's lottery ticket is a winning lottery ticket and the winning amount is $600 or more, a courier processing clerk retrieves the stored winning physical player lottery ticket from the courier storage location and sends that printed draw lottery ticket to the player so that the player can cash in that lottery ticket and obtain the winning amount.

For a better understanding of various embodiments of the lottery systems and methods of the present disclosure, certain encryption, decryption, and hashing systems and methods are now described.

In cryptography, encryption is the process of encoding information. This process converts the original representation of the information (known as plaintext) into an alternative form (known as ciphertext). Ideally, only authorized parties can decipher a ciphertext back to plaintext and access the original information. Encryption does not itself prevent interference but denies the intelligible content to a would-be interceptor. Encryption can be performed using a secret key of some kind. It is thus generally only possible to decrypt the ciphertext if the secret key is known. There is typically no loss of information between the original text or decrypted ciphertext. The encryption process can include chained encryption where the result of the first encryption is encrypted again using a different secret key. Chained encryption can include performing the encryption process one or more additional times with different secret keys. Decryption is performed backward using the last secret key, then the next to last secret key, etc.

Hashing is a function that is used to map data of an arbitrary size to a static-size value, though there are some hash functions that provide a variable length output. The value returned by a hash function is called a hash value, a hash code, a hash digest, a digest, or simply a hash. Hashing is a one-way function. In other words, once an original text has been hashed, it is not normally feasible to determine the original text if only the hash is known. Typically, determining the original text using the hash value can be done only by trying all possible original texts and determining if the hash of each candidate is the same as the hash of the original. By adding additional secret text to the original text, it is possible to lengthen the calculations and thus time required to try all possible values. This is called salting the hash. Another option for hashing is a keyed hash. This is a different kind of hash function (sometimes called a hash message authentication code, or HMAC) where the hash is performed on the original data, and this hashing method uses a separate set of data called a key. By varying the key, the same original text can hash into different hashed results.

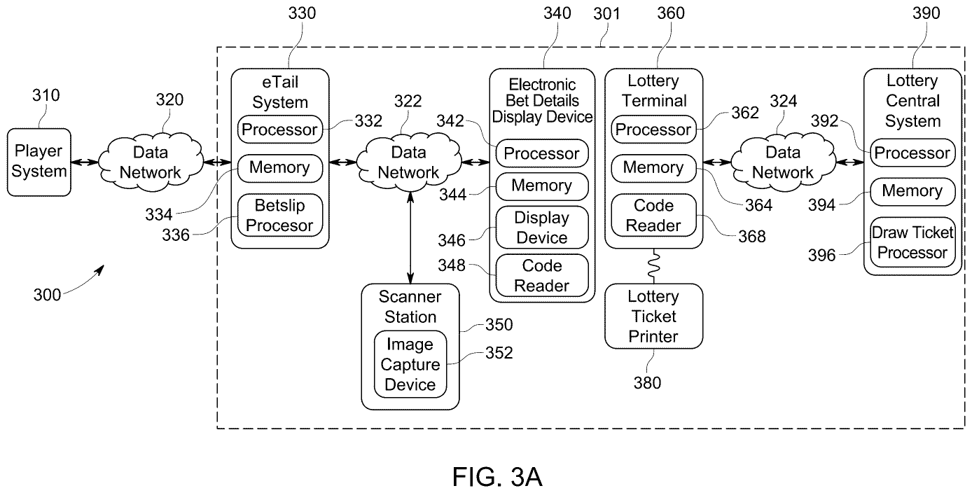

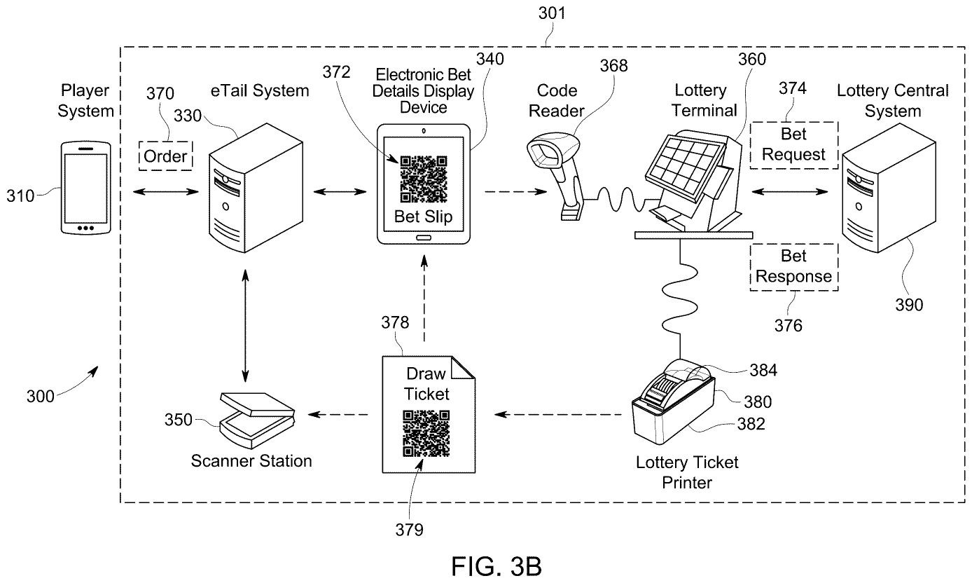

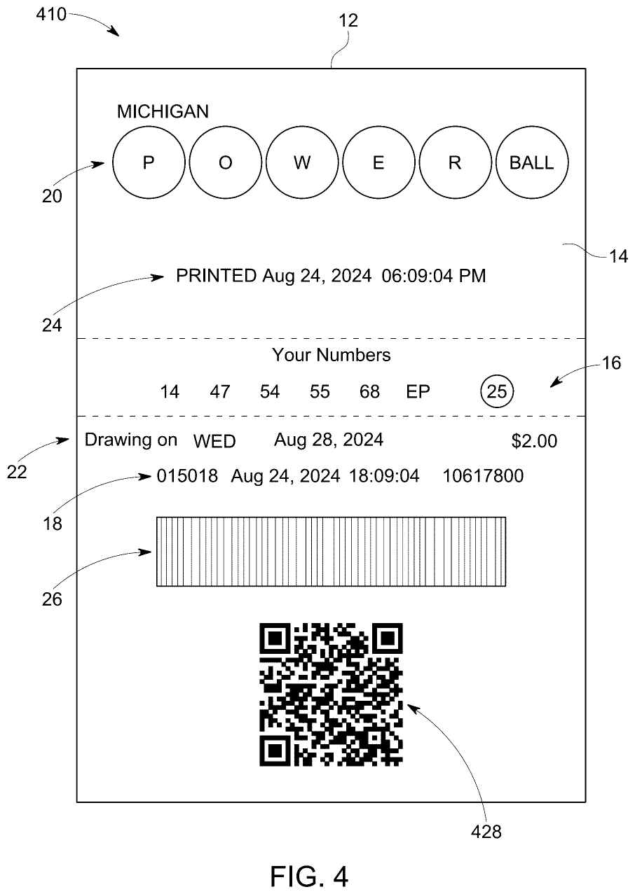

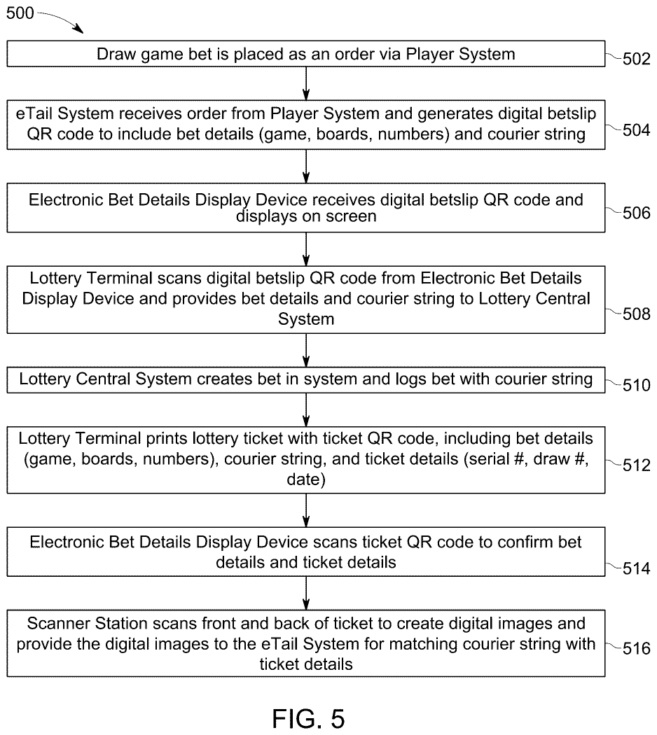

Turning now to FIG. 3A and FIG. 3B, an example lottery ticket selling system 300 in accordance with one example embodiment of the present disclosure is shown. An example embodiment of a printed draw lottery ticket 410 employed by the lottery ticket selling system 300 is shown in FIG. 4. An example method 500 of operating the lottery ticket selling system 300 in accordance with one example embodiment of the present disclosure is shown in FIG. 5 and described below. While these examples explain various embodiments of the present disclosure in relation to an electronic ticket retail server or courier server (and related systems and methods), the present disclosure can be employed with other suitable servers, systems, and methods that are not courier related.

This illustrated example embodiment of the present disclosure provides the lottery ticket selling system 300 including: (a) a player system 310; (b) an electronic ticket retail server 330; (c) an electronic bet details display device 340; (d) a scanner station 350; (e) a lottery terminal 360; (f) a lottery ticket printer 380; and (g) a lottery central system 390. In various embodiments, the lottery ticket selling system 300 includes a ticket tracking system 301 that enables an original purchaser (also sometimes referred to herein as a “player”) to employ the player system 310 to remotely electronically purchase one or more draw lottery tickets for one or more draw lottery games without physically visiting a lottery terminal at a retail location. In various embodiments, the ticket tracking system 301 includes a courier system.

Various embodiments of the present disclosure are directed to the electronic ticket retail server 330 (also referred to herein as “eTail system 330”) itself and methods of operation thereof (such as the eTail system 330 and method of operation thereof described herein).

Various other embodiments of the present disclosure are directed to the eTail system 330 and the electronic bet details display device 340 and methods of operation thereof.

Various other embodiments of the present disclosure are directed to the eTail system 330, the electronic bet details display device 340, and the scanner station 350 and methods of operation thereof.

Various other embodiments of the present disclosure are directed to the eTail system 330, the electronic bet details display device 340, and the lottery terminal 360 and methods of operation thereof.

Various other embodiments of the present disclosure are directed to the eTail system 330, the electronic bet details display device 340, the lottery terminal 360, and the lottery central system 390 and methods of operation thereof.

Various other embodiments of the present disclosure are directed to the lottery terminal 360 and methods of operation thereof.

Various other embodiments of the present disclosure are directed to the lottery central system 390 itself and methods of operation thereof.

In this illustrated example embodiment, the player system 310 and the eTail system 330 are configured to communicate with each other via a suitable data network 320 such as but not limited to a cellular data network or the Internet.

In this illustrated example embodiment, the eTail system 330 and the electronic bet details display device 340 are configured to communicate with each other via a suitable data network 322 such as but not limited to a cellular data network or the Internet. In other embodiments, the communication between these components can be via hard wire connection such as a USB connector, via wireless connection such as Bluetooth, or other suitable data connection.

In this illustrated example embodiment, the eTail system 330 and the scanner station 350 are configured to communicate with each other via the data network 322. In other embodiments, the communication between these components can be via another suitable data network or via the electronic bet details display device 340 (e.g., via hard wire such as an USB connector, wireless connection such as Bluetooth, a data network, etc.).

In this illustrated example embodiment, the lottery terminal 360 and the lottery ticket printer 380 are configured to communicate with each other via hard wire such as an USB connector. In other embodiments, the communication between these components can be via a suitable data network. In other embodiments, the lottery ticket printer 380 can be built into the same housing as the lottery terminal 360 and thus be physically connected by hard wires.

In this illustrated example embodiment, the lottery terminal 360 and the lottery central system 390 are configured to communicate with each other via a suitable data network 324 such as a cellular data network, the Internet, or a private secure network.

In various embodiments, the player system 310 includes a player electronic device with a mobile application (not shown) downloaded thereon. The player electronic device can include an electronic smartphone, an electronic tablet, an electronic watch, or other suitable electronic computing device with suitable data communication, user input, and display functions. The player system 310 includes a processor (not shown) and a memory device (not shown) that includes instructions that when executed by the processor cause and/or configure the processor to provide functionality as described herein. In various embodiments, the mobile application includes instructions stored in the memory device of the player system 310. In various embodiments, all, or a portion of the functionality of the mobile application can be implemented using application-specific integrated circuits or other suitable hardware. In various embodiments, the mobile application of the player system 310 includes a courier mobile application such as the courier mobile application as described above or any other suitable courier mobile application.

The mobile application of the player system 310 enables a player (e.g., an original purchaser) of the player system 310 to purchase a draw lottery ticket and obtain that purchased draw lottery ticket without physically visiting a lottery terminal at a retail location. In various embodiments, the original purchaser obtains the purchased draw lottery ticket as: (a) a printed draw lottery ticket; (b) a digital (or virtual) draw lottery ticket; or (c) both a printed draw lottery ticket and a digital draw lottery ticket. In some embodiments, the lottery ticket selling system 300 causes each purchased draw lottery ticket to be printed, but printed draw lottery tickets are provided to the original purchaser in only certain scenarios, such as when the purchased draw lottery ticket is identified as a winning draw lottery ticket, when the purchased draw lottery ticket has a winning amount over a threshold (e.g., $600 or more), or when requested by the original purchaser. In some embodiments, the original purchaser receives the digital draw lottery ticket at a first time (e.g., via the mobile application after the purchase) and receives the printed draw lottery ticket at a second, later time (e.g., after the printed draw lottery ticket is identified as a winning draw lottery ticket). In some embodiments, the printed draw lottery ticket is stored (e.g., as part of a courier service), but not physically delivered to the original purchaser (e.g., when the printed draw lottery ticket is not a winning ticket, has a winning amount less than $600, etc.).

In various embodiments, the mobile application is configured to: (a) enable a player to use the mobile application on the player system 310 to set up a player account with the eTail system 330; (b) deposit funds to the player account; (c) withdraw funds from the player account; (d) use funds in the player account to purchase a draw lottery ticket for a draw lottery game; (e) generate a lottery ticket order (such as a lottery ticket order 370) for the purchase of the draw lottery ticket; (f) cause the player system 310 to send the lottery ticket order to the eTail system 330; (g) view ticket details for the purchased draw lottery ticket; and/or (h) view images of the purchased draw lottery ticket.

In various embodiments, the eTail system 330 includes a processor 332, a memory device 334 including instructions that when executed by the processor 332 cause and/or configure the processor 332 to provide at least the functionality as described herein, and a bet slip processor 336. In various embodiments, the bet slip processor 336 includes instructions stored in the memory device 334. The processor 332 may be referred to as a “server processor” herein for clarity but is not limited to server processors or server class processors and can include any suitable processor. The memory device 334 may be referred to as a “server memory device” herein for clarity but is not limited to server memory devices or server class memory devices and can include any suitable memory device. In various embodiments, all, or a portion of the functionality of the eTail system 330 can be implemented using application-specific integrated circuits or other suitable hardware. In various embodiments, the eTail system 330 includes a courier server, such as the courier server 130, located at a suitable courier processing center (not shown).

In various embodiments, the eTail system 330 is configured to generate a ticket purchase identifier employable to associate a draw lottery ticket (purchased draw lottery ticket or printed draw lottery ticket) with an original purchaser of that draw lottery ticket. The eTail system 330 generates the ticket purchase identifier for the draw lottery ticket prior to a purchase of that draw lottery ticket. In various embodiments, the ticket purchase identifier includes an eTail system identifier and an original purchaser identifier, as described herein. The original purchaser identifier is employable to associate the draw lottery ticket with an original purchaser of that draw lottery ticket. That is, an identity of the original purchaser of the player system 310 is identifiable using the ticket purchase identifier.

In various embodiments, the ticket purchase identifier includes a field or string of data. In some embodiments, the field includes a first sub-field for the eTail system identifier and a second sub-field for the original purchaser identifier. In some embodiments, different eTail systems employ different lengths of the first and second sub-fields. In various embodiments, the ticket purchase identifier includes other suitable information that is associated with a courier service, such as an order ID associated with the lottery ticket order 370, a bundle ID associated with a bundle of printed draw lottery tickets, and/or a digital fingerprint associated with the original purchaser. In various embodiments, the ticket purchase identifier is independent from data associated with the lottery central system 390.

In various embodiments, the eTail system 330 is configured to: (a) receive a lottery ticket order (such as the lottery ticket order 370) from the player system 310; (b) generate a digital bet slip (such as a digital bet slip QR code 372) for a purchase of a draw lottery ticket based on the lottery ticket order; (c) send the digital bet slip to the electronic bet details display device 340 to enable the display of the digital bet slip QR code 372 that in turn enables the purchase of the draw lottery ticket; (d) receive ticket details for a printed draw lottery ticket (such as the printed draw lottery ticket 378) from the electronic bet details display device 340; (e) receive ticket image data for the printed draw lottery ticket from the scanner station 350; and/or (f) provide the ticket details and/or ticket image data to the player system 310. In various embodiments, the eTail system 330 generates the digital bet slip to include the ticket purchase identifier.

In various embodiments, the eTail system 330 is configured to enable a courier service, for example, to deposit funds to a player account, to withdraw funds from the player account, and to use funds in the player account to purchase a draw lottery ticket for a lottery game.

In various embodiments, the eTail system 330 can randomly select player numbers for a draw lottery ticket responsive to a quick pick indication by the player.

The electronic bet details display device 340 includes a display device 346 (such as an LCD or OLED display). In various embodiments, the electronic bet details display device 340 includes a processor 342 and a memory device 344. In various embodiments, the electronic bet details display device 340 includes a code reader 348, such as a quick response (QR) code reader, a barcode reader, an image capture device, CIS reader, or other suitable reader. The memory device 344 includes instructions that when executed by the processor 342 cause and/or configure the processor 342 to provide functionality as described herein. The processor 342 may be referred to as a “tablet processor” herein for clarity but is not limited to tablet processors or tablet class processors and can include any suitable processor. The memory device 334 may be referred to as a “tablet memory device” herein for clarity but is not limited to tablet memory devices or tablet class memory devices and can include any suitable memory device. In various embodiments, all, or a portion of the functionality of the electronic bet details display device 340 can be implemented using application-specific integrated circuits or other suitable hardware.

The electronic bet details display device 340 is configured to: (a) receive a digital bet slip (such as the digital bet slip QR code 372) from the eTail system 330; (b) display the digital bet slip on the display device 346 to enable the lottery terminal 360 to scan the displayed digital bet slip; (c) scan a draw ticket QR code on a printed draw lottery ticket (such as the printed draw lottery ticket 378) to obtain scanned draw ticket QR code data; and/or (d) provide the scanned draw ticket QR code data to the eTail system 330.

In various embodiments, the scanner station 350 includes a lottery ticket scanner having a housing (not shown), a processor (not shown) supported by the housing, a memory device (not shown) supported by the housing, and an image capture device 352 supported by the housing. In various embodiments, the image capture device 352 includes a charge coupled device (CCD) image sensor, an active pixel sensor, and/or other suitable digital image sensor. In some embodiments, the housing includes a ticket inlet (not shown) configured to receive a printed draw lottery ticket.

The image capture device 352 is configured to: (a) capture ticket image data for a front surface and/or a rear surface of a printed draw lottery ticket; and (b) provide the ticket image data to the eTail system 330. In various embodiments, the image capture device 352 is configured to capture the ticket image data as still image(s) of the printed draw lottery ticket. In various embodiments, the image capture device 352 can include a digital camera, is not a video camera, or is not configured to capture video of the printed draw lottery ticket. In such embodiments, the ticket image data is relatively small in size as compared to video data that might be captured by a video camera. In such embodiments, the ticket image data is readily transmitted via the data network 322 (e.g., using less bandwidth, having a reduced transmission time, and using reduced processing resources). In various embodiments, the scanner station 350 includes an additional image capture device (not shown) configured to capture the ticket image data for the rear surface of the printed draw lottery ticket. In such embodiments, the image capture device 352 captures ticket image data for the front surface of the printed draw lottery ticket.

In various embodiments, the scanner station 350 includes one or more mirrors (not shown) or other reflective surfaces to enable the image capture device 352 to capture the ticket image data. In various embodiments, the scanner station 350 includes additional actuators (not shown) that are configured to present both the front surface and the rear surface of the printed draw lottery ticket to the image capture device 352, for example, by flipping the printed draw lottery ticket over, moving and/or rotating the image capture device 352, and/or moving the mirrors.

The lottery terminal 360 includes a processor 362, a memory device 364, and a code reader 368. The memory device 364 includes instructions that when executed by the processor 362 cause and/or configure the processor 362 to provide functionality as described herein. The processor 362 may be referred to as a “terminal processor” herein for clarity but is not limited to lottery terminal processors or lottery terminal class processors and can include any suitable processor. The memory device 364 may be referred to as a “terminal memory device” herein for clarity but is not limited to lottery terminal memory devices or lottery terminal class memory devices and can include any suitable memory device. In various embodiments, the code reader 368 includes a quick response (QR) code reader, a barcode reader, an image capture device, CIS reader, or other suitable reader. In various embodiments, the lottery terminal 360 includes the lottery terminal 160. In various embodiments, all, or a portion of the functionality of the lottery terminal 360 can be implemented using application-specific integrated circuits or other suitable hardware.

In various embodiments, the lottery terminal 360 is configured to: (a) employ the code reader 368 to scan a bet slip (such as the digital bet slip QR code 372) to obtain scanned bet slip data; (b) generate a bet request (such as a bet request 374) based on the scanned bet slip data; (c) send the bet request to the lottery central system 390 to cause a purchase of a draw lottery ticket based on the scanned bet slip data; (d) receive a bet response from the lottery central system 390 (such as a bet response 376); and/or (e) cause the lottery ticket printer 380 to print the purchased draw lottery ticket (such as the printed draw lottery ticket 410) based on the bet response.

In various embodiments, the lottery terminal 360 generates and provides a lottery ticket printing request to the lottery ticket printer 380 to cause the purchased draw lottery ticket to be printed. The lottery ticket printing request includes ticket details and a ticket purchase identifier for the purchased draw lottery ticket. The ticket details can include an indication of the draw lottery game, the date of the play of the draw lottery game that the draw lottery ticket relates to, and the player numbers for the play of the draw lottery game. In various embodiments, the lottery terminal 360 generates the lottery ticket printing request to include a draw ticket QR code (such as a draw ticket QR code 379 or 428) on the printed draw lottery ticket. The draw ticket QR code enables an association of that printed draw lottery ticket with the original purchaser and facilitates identification of that original purchaser, as described herein. The draw ticket QR code can also or alternatively enable an association of that printed draw lottery ticket with the original purchaser account that can facilitate identification of that original purchaser.

In various embodiments, the lottery terminal 360 is configured to store recent scanned bet slip data for one or more recent bet slips. For example, the lottery terminal 360 can store recent bet slip data for ten most recent bet slips that have been scanned. In some such embodiments, the lottery terminal 360 employs the recent scanned bet slip data to prevent generation of duplicate bet requests for a same digital bet slip by preventing such generation when the scanned bet slip data matches any of the stored recent bet slip data. In some such embodiments, the lottery terminal 360 enables an operator of the lottery terminal 360 to provide a user input confirmation to proceed with generating a duplicate bet request (e.g., in case of an error or other fault that causes a same bet slip to be scanned repeatedly).

The lottery ticket printer 380 includes: (a) a printer housing 382; (b) a supply paper holder 384; (c) a plurality of roll engagers (not shown) supported by the printer housing; and (d) a controller (not shown). The lottery ticket printer 380 is configured to print draw lottery tickets, such as a printed draw lottery ticket 378. In various embodiments, the lottery ticket printer 380 receives a lottery ticket printing request (or lottery ticket image) associated with a draw lottery ticket and prints that draw lottery ticket. In various such embodiments, the lottery ticket printer 380 receives the lottery ticket printing request from the lottery terminal 360 and/or the lottery central system 390.

The lottery central system 390 includes a processor 392, a memory device 394, and a draw ticket processor 396. The memory device 394 includes instructions that when executed by the processor 392 cause and/or configure the processor 392 to provide functionality as described herein. In various embodiments, the draw ticket processor 396 includes instructions stored in the memory device 394. The processor 392 may be referred to as a “central system processor” herein for clarity but is not limited to central system processors or central system class processors and can include any suitable processor. The memory device 394 may be referred to as a “central system memory device” herein for clarity but is not limited to central system memory devices or central system class memory devices and can include any suitable memory device. In various embodiments, the lottery central system 390 includes a server or other suitable computing device, such as the lottery central system 200. In various embodiments, all, or a portion of the functionality of the lottery central system 390 can be implemented using application-specific integrated circuits or other suitable hardware.

In various embodiments, the lottery central system 390 is configured to: (a) receive a bet request (such as the bet request 374) for the purchase of a draw lottery ticket from the lottery terminal 360; (b) obtain bet details for the purchase and a ticket purchase identifier from the bet request; (c) randomly select draw numbers for the bet request (e.g., for a quick pick indication); (d) generate a bet for the purchase of a draw lottery ticket based on the bet details; (e) log (such as store) the bet and the ticket purchase identifier; (f) generate and send a bet response (such as the bet response 376) for the bet request to the lottery terminal 360; (g) process lottery ticket redemption requests for draw lottery tickets; and/or (h) other lottery ticket related functionality. In various embodiments, the lottery central system 390 generates the bet response to include the ticket purchase identifier and ticket details for the purchased draw lottery ticket.

Referring to FIG. 4, an example embodiment of a printed draw lottery ticket 410 employed by the lottery ticket selling system 300 is shown. In various embodiments, the printed draw lottery ticket 410 includes ticket details for a purchased draw lottery ticket and the ticket purchase identifier for that purchased draw lottery ticket. In various embodiments, the ticket details of the printed draw lottery ticket 410 include one or more features of the physical draw lottery ticket 10, such as the player numbers 16, the ticket identifier 18, the game identifier 20, the draw date 22, the print date 24, and/or the ticket barcode 26. In various embodiments, one or more of the ticket details, the ticket purchase identifier, and/or other suitable information have a human readable format on the printed draw lottery ticket 410, such as a text format or image format. In various embodiments, one or more of the ticket details, the ticket purchase identifier, and/or other suitable information have a format that is not readily human readable, such as an encoded format or encrypted format. In various embodiments, the printed draw lottery ticket 410 includes at least some information in a human readable format and at least some information in a format that is not readily human readable. In some such embodiments, the printed draw lottery ticket 410 includes at least some information in both a human readable format and a format that is not readily human readable (e.g., a ticket serial number provided as plain text and as a barcode).

In various embodiments, the printed draw lottery ticket 410 includes a draw ticket QR code 428 that includes the ticket purchase identifier. In various embodiments, the draw ticket QR code 428 includes the ticket purchase identifier, the ticket details for the printed draw lottery ticket 410, and/or other suitable information. In various embodiments, the draw ticket QR code 428 is different from the digital bet slip QR code 372. In some such embodiments, the draw ticket QR code 428 includes the ticket serial number (e.g., ticket identifier 18) or other suitable information that was not included in the digital bet slip QR code 372. In some such embodiments, the draw ticket QR code 428 includes information that was not yet generated by the lottery central system 390 or was unavailable to the eTail system 330 when the digital bet slip QR code 372 was generated by the eTail system 330.

Referring now to FIG. 3B and FIG. 5, an example method 500 of purchasing a draw lottery ticket using the lottery ticket selling system 300 is now described. Although the method is described with reference to the flowchart shown in FIG. 5, other methods of performing the acts associated with this illustrated process may be employed. For example, the order of certain of the illustrated blocks may be changed, certain of the illustrated blocks may be optional, or certain of the illustrated blocks may not be employed.

In this example system and method for purchasing a draw lottery ticket, a draw game bet is placed with the eTail system 330 as a lottery ticket order 370 via the player system 310, as indicated at block 502. In various embodiments, the mobile application of the player system 310 enables a player (i.e., an original purchaser) to input the player's selected numbers or a quick pick indication for a draw lottery ticket for a draw lottery game that the player wishes to purchase and thus play (such as by interacting with a graphical user interface, scanning a new or previously used bet slip or draw lottery ticket, scanning a draw ticket QR code from another purchased draw lottery ticket, or identifying a previously purchased draw lottery ticket with player numbers for repurchase).

In various embodiments, the player system 310 generates the lottery ticket order 370 to include bet details for the purchase of the draw lottery ticket. The bet details can include a requested draw game identifier that identifies a lottery game type, a requested draw date (e.g., the “boards” to be played), the player selected numbers, player numbers selected by the player system 310, and/or the quick pick indication. The player system 310 sends the lottery ticket order 370 to the eTail system 330 via the data network 320 (FIG. 3A).

In various embodiments and/or scenarios, the mobile application generates the lottery ticket order request to include: (1) ticket information for a single draw lottery ticket; (2) ticket information for multiple draw lottery tickets for a same lottery game and for a same player; and/or (3) ticket information for multiple draw lottery tickets for different lottery games for a same player. In other words, the lottery ticket order request can be associated with one, two, three, or more draw lottery tickets for one, two, three or more draw lottery games.

The eTail system 330 receives the lottery ticket order 370 from the player system 310 and generates a digital bet slip to include the bet details and a ticket purchase identifier (also referred to herein as a “courier string”), as indicated at block 504. The digital bet slip is employable by the lottery terminal 360 to cause a purchase of a draw lottery ticket based on the bet details. In various embodiments, the eTail system 330 employs the bet details from the lottery ticket order 370 to generate the digital bet slip. In some embodiments, the eTail system 330 randomly generates player numbers for the digital bet slip, for example, based on a quick pick indication within the lottery ticket order 370.

The eTail system 330 generates the ticket purchase identifier prior to the purchase of the draw lottery ticket, which enables tracking of the purchased draw lottery ticket and/or association of the purchased draw lottery ticket with the original purchaser. In some embodiments, the ticket purchase identifier enables a complete mapping of the purchase, including a lottery ticket order, a digital bet slip, a bet request, a stored bet for purchased draw lottery ticket, a bet response, and a printed draw lottery ticket, as described herein.

In various embodiments, the eTail system 330 generates the digital bet slip to include a digital bet slip QR code, such as the digital bet slip QR code 372. In such embodiments, the eTail system 330 encodes the bet details and the ticket purchase identifier into the digital bet slip QR code 372. In various embodiments, the digital bet slip QR code 372 improves the speed at which the bet details and ticket purchase identifier can be scanned, for example, by providing a single scan region from which the bet details and ticket purchase identifier can be scanned, instead of multiple distinct regions for each field of the bet details (i.e., a player number region, a game type region, a draw date region, etc.). In some embodiments, the digital bet slip QR code 372 enables error detection and/or error correction when scanning the bet details.

In various embodiments, the ticket purchase identifier includes an eTail system identifier associated with an operator of the eTail system 330 and/or an original purchaser identifier associated with the original purchaser. The eTail system identifier enables identification of the operator of the eTail system 330 through which the digital bet slip QR code 372 was received. The original purchaser identifier enables identification of the original purchaser. In various embodiments, the eTail system 330 provides a courier service with a player account for the original purchaser and the ticket purchase identifier is referred to herein as a “courier string”. In various embodiments, different eTail systems employ different courier strings.

In various embodiments, the original purchaser identifier includes an original purchaser digital signature, such as a data structure, data file, data bit sequence, data token, or other suitable digital identifier, that does not by itself uniquely identify the original purchaser, but can be used to uniquely identify the original purchaser using a suitable cryptographic function. In various embodiments, the cryptographic function includes a hash function, a keyed hash function, an encryption function, a decryption function, or other suitable cryptographic function. In various embodiments, the eTail system 330 (or another suitable entity) employs original purchaser identifying information as a parameter or input to the cryptographic function to generate the original purchaser identifier. In some such embodiments, the original purchaser identifier is not readily human readable. In some other embodiments, the original purchaser identifier includes a human readable identifier that uniquely identifies the original purchaser (i.e., without the use of the cryptographic function).

In various embodiments, the original purchaser identifier includes a hash string based on the original purchaser identifying information. In such embodiments, identification and/or verification of the original purchaser is performed by the original purchaser providing the original purchaser identifying information to regenerate the original purchaser identifier (e.g., when redeeming a winning draw lottery ticket). In various embodiments, the original purchaser identifier includes encrypted data, such as an encrypted copy of the original purchaser identifying information (or other suitable data) generated using an encryption key (such as a public key). In such embodiments, the identification and/or verification of the original purchaser is performed by the original purchaser providing a decryption key (such as a private key) associated with the original purchaser to enable decryption of the encrypted data.

In various embodiments, original purchaser identifying information can include, for example: (1) the original purchaser's full name, residential address, and phone number; (2) Government-issued ID number (e.g., social security number, license number, passport number, tax identifier); (3) a biometric and/or physical identifier (e.g., thumbprint); (4) a suitable account number (e.g., bank account number, utility account number); (5) a group ID number or identifier; (6) a group member identifier; (7) the answers to ‘challenge’ questions, such as the player's first pet, where the player was born, etc. ; and/or (8) or other suitable personal identifying information (PII).

In various embodiments, for example, the original purchaser provides their tax identifier and a challenge question answer to the eTail system 330 for generation of the original purchaser identifier as a hash of the tax identifier and the challenge question answer. In such embodiments, the original purchaser provides the same tax identifier and challenge question answer when redeeming a winning draw lottery ticket to re-generate the original purchaser identifier and authenticate the original purchaser.

After its generation, the eTail system 330 sends the digital bet slip QR code 372 to the electronic bet details display device 340.

The electronic bet details display device 340 receives and displays the digital bet slip QR code 372, for example, on the display device 346, as indicated at block 506. In some embodiments, the electronic bet details display device 340 is positioned and/or oriented to enable the code reader 368 to automatically scan the displayed digital bet slip QR code 372. In some embodiments, the electronic bet details display device 340 is positioned and/or oriented to enable a courier processing clerk to employ the code reader 368 to scan the displayed digital bet slip QR code 372.

The code reader 368 of the lottery terminal 360 scans the digital bet slip QR code 372 from the electronic bet details display device 340 and provides bet details and the ticket purchase identifier (e.g., the courier string) to the lottery central system 390, as indicated at block 508. That is, the lottery terminal 360 employs the code reader 368 to scan the displayed digital bet slip QR code to obtain scanned bet slip data. In various embodiments, the lottery terminal 360 generates a bet request 374 for the purchase of the draw lottery ticket and the bet request 374 includes the bet details and the ticket purchase identifier based on the scanned bet slip data. The lottery terminal 360 sends the bet request 374 to the lottery central system 390 via the data network 324 to cause the purchase of the draw lottery ticket based on the scanned bet slip data.

The lottery central system 390 creates a bet in the lottery central system 390 and logs the bet with the ticket purchase identifier (e.g., the courier string), as indicated at block 510. In various embodiments, the lottery central system 390 receives the bet request 374 and obtains the bet details and the ticket purchase identifier. The lottery central system 390 creates the bet for the purchased draw lottery ticket based on the bet details and logs the bet with the ticket purchase identifier. In various embodiments, the bet and any associated printed draw lottery tickets are themselves associated with the original purchaser based on the ticket purchase identifier. The bet includes ticket details for the purchased draw lottery ticket, such as a ticket serial number (e.g., ticket identifier 18), player numbers, a security code that facilitates authentication of the purchased draw lottery ticket, or other suitable ticket information. In various embodiments, the ticket purchase identifier is independent from the ticket details. In various embodiments, a valid draw lottery ticket includes only ticket details, such as when purchased from the courier server 130 or lottery terminal 160. In various embodiments, a valid draw lottery ticket, when purchased via the eTail system 330, includes: (a) the ticket details and the ticket purchaser identifier; (b) the ticket details, the bet details, and the ticket purchaser identifier; (c) the ticket purchase identifier and at least some of the ticket details; and/or (d) the ticket purchase identifier, at least some of the ticket details, and at least some of the bet details.

After creation of the bet, the lottery central system 390 generates and provides a bet response 376 to the lottery terminal 360. In various embodiments, the bet response 376 includes a confirmation of the purchase of the draw lottery ticket, the ticket purchase identifier associated with that purchased draw lottery ticket (i.e., from the bet request 374), and/or other suitable ticket information. In various embodiments, the confirmation includes the ticket details for the draw lottery ticket, such as the ticket serial number and player numbers.

The lottery terminal 360 prints the purchased draw lottery ticket (shown as printed draw lottery ticket 378) with a draw ticket QR code 379 including the bet details, the ticket purchase identifier (e.g., the courier string), and the ticket details, as indicated at block 512. In various embodiments, the lottery terminal 360 obtains the bet details (e.g., the game identifier, the draw date, the player numbers), the ticket details (e.g., the ticket serial number), and the ticket purchase identifier from the bet response 376 and causes the lottery ticket printer 380 to print the printed draw lottery ticket 378. In various embodiments, the lottery terminal 360 stores copies of the bet details and the ticket purchase identifier from the scanned bet slip data and employs the stored copies to print the purchased draw lottery ticket.

In various embodiments, the lottery terminal 360 generates and provides lottery ticket printing data (e.g., printer commands, image data, etc.) to the lottery ticket printer 380 to cause the printed draw lottery ticket 378 to be printed. In such embodiments, the lottery ticket printing data includes the bet details, the ticket details, and the ticket purchase identifier.

In various embodiments, the lottery terminal 360 encodes the bet details, the ticket details, the ticket purchase identifier, and/or other suitable ticket information into the draw ticket QR code 379 and causes the printed draw lottery ticket 378 to include the draw ticket QR code 379. In some embodiments, the printed draw lottery ticket 378 includes at least some of the ticket details and/or bet details only within the draw ticket QR code 379, such as only including the player numbers within the draw ticket QR code 379. In some embodiments, fraud associated with a stolen or lost draw lottery ticket is prevented by requiring the draw ticket QR code 379 to be decoded to determine whether the draw lottery ticket is a winning draw lottery ticket. In some embodiments, the printed draw lottery ticket 378 includes only the draw ticket QR code 379 and does not include any human readable information.

The electronic bet details display device 340 scans the ticket QR code on the printed draw lottery ticket 378 to confirm the bet details and the ticket details, as indicated at block 514. In various embodiments, the electronic bet details display device 340 employs the code reader 348 to scan the draw ticket QR code 379 to obtain scanned draw ticket QR code data. The electronic bet details display device 340 provides the scanned draw ticket QR code data to the eTail system 330 to enable a confirmation of the bet details and the ticket details. In various embodiments, the eTail system 330 compares the ticket details for the purchased draw lottery ticket with the bet details from the digital bet slip QR code 372 to ensure that the purchased draw lottery ticket matches the lottery ticket order 370 of the original purchaser (i.e., matching player numbers, matching draw date, etc.). In other words, the eTail system 330 validates that the lottery ticket order 370 has been properly fulfilled.

The lottery ticket selling system 300 enables improved bet and ticket detail matching by employing a single scan region (i.e., the draw ticket QR code 379) from which the ticket details and ticket purchase identifier can be scanned, instead of multiple distinct regions for each field of the ticket details. In some embodiments, the draw ticket QR code 379 enables error detection and/or error correction when scanning the ticket details. In some embodiments, the eTail system 330 is enabled to provide faster matching of the printed draw lottery ticket to the lottery ticket order 370 and can more quickly process additional digital bet slip QR codes for other lottery ticket orders. In some embodiments, the eTail system 330 is configured to generate and process batches of digital bet slip QR codes. For example, the eTail system 330 provides a plurality of digital bet slip QR codes for related lottery ticket orders (e.g., orders having a same original purchaser, orders associated with a same draw lottery game, orders associated with a same geographical area or jurisdiction, etc.).

The scanner station 350 scans the front and back of the printed draw lottery ticket 378 to create digital images (e.g., ticket image data) and provides the digital images to the eTail system 330 for matching of the (e.g., the courier string) with the ticket details, as indicated at block 516. In various embodiments, the eTail system 330 and/or the electronic bet details display device 340 cause the scanner station 350 to scan the printed draw lottery ticket 378. In various embodiments, the scanner station 350 automatically scans the printed draw lottery ticket 378, for example, when the printed draw lottery ticket 378 is placed and/or fed into the ticket inlet of the scanner station 350.

In various embodiments, the scanner station 350 scans and/or provides the ticket image data to the eTail system 330 independently from the electronic bet details display device 340 providing the scanned ticket QR code data to the eTail system 330. In some such embodiments, the eTail system 330 is enabled to receive the scanned ticket data from the electronic bet details display device 340 and quickly provide a confirmation to the original purchaser without waiting for the ticket image data to be received. In some such embodiments, the eTail system 330 is not affected by potential delays associated with scanning the printed draw lottery ticket (or other printed draw lottery tickets), such as moving the printed draw lottery tickets to the scanner station 350, feeding the printed draw lottery tickets through the scanner station 350, and transferring the ticket image data to the eTail system 330.

In various embodiments, the eTail system 330 employs a maximum allowed size for the digital bet slip QR code 372 and/or the ticket QR code, for example, a maximum scanned code size associated with the code reader 368 and/or a maximum printable code size associated with the lottery ticket printer 380. In such embodiments, the eTail system 330 generates the ticket purchase identifier such that the digital bet slip QR code 372 and/or the ticket QR code, which include the bet details and the ticket purchase identifier, do not exceed the maximum allowed size.

In various embodiments, the lottery ticket selling system 300 employs another printed format and/or physical structure for providing the information encoded within the draw ticket QR code 379 with the printed draw lottery ticket 378, such as a barcode printed on the printed draw lottery ticket 378, a radio frequency ID tag affixed to the printed draw lottery ticket 378, an encoded image printed on the printed draw lottery ticket 378, other suitable data formats, and/or other suitable data structures. In various embodiments, the lottery ticket selling system 300 employs this other format and/or physical structure alternatively, or in addition to, the draw ticket QR code.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket selling system comprising:
an electronic bet details display device;
a lottery terminal associated with a code reader and a lottery ticket printer, the lottery terminal comprising a terminal processor and a terminal memory device that stores a first plurality of instructions; and
an electronic ticket retail server comprising a server processor and a server memory device that stores a second plurality of instructions, which when executed by the server processor, cause the server processor to:
receive an order from a player electronic device associated with an original purchaser, the order comprising bet details for a purchase of a draw lottery ticket;
generate a ticket purchase identifier for the draw lottery ticket prior to the purchase of the draw lottery ticket, wherein the original purchaser is uniquely identifiable using the ticket purchase identifier;
generate a digital bet slip that comprises the bet details for the draw lottery ticket and the ticket purchase identifier; and
send the digital bet slip to the electronic bet details display device such that the electronic bet details display device receives and displays the digital bet slip;
wherein the first plurality of instructions stored on the terminal memory device, when executed by the terminal processor, cause the terminal processor to:
employ the code reader to scan the displayed digital bet slip to obtain scanned bet slip data;
cause the purchase of the draw lottery ticket based on the scanned bet slip data; and
cause the lottery ticket printer to print the purchased draw lottery ticket, the printed draw lottery ticket comprising ticket details and the ticket purchase identifier.

2. The lottery ticket selling system of claim 1, wherein the ticket purchase identifier comprises an original purchaser identifier employable to associate the purchased draw lottery ticket with the original purchaser.

3. The lottery ticket selling system of claim 2, wherein the original purchaser identifier is employable to identify the original purchaser.

4. The lottery ticket selling system of claim 3, wherein the original purchaser identifier comprises an original purchaser digital signature that does not by itself uniquely identify the original purchaser.

5. The lottery ticket selling system of claim 4, wherein the original purchaser digital signature is employable with a cryptographic function to uniquely identify the original purchaser.

6. The lottery ticket selling system of claim 1, wherein the ticket purchase identifier comprises a system identifier associated with an operator of the electronic ticket retail server.

7. The lottery ticket selling system of claim 1, wherein:
the bet details comprise a draw game identifier that identifies a lottery game type, a draw date, and player numbers for the purchase of the draw lottery ticket;
the ticket details comprise a draw game identifier for the purchased draw lottery ticket, a draw date for the purchased draw lottery ticket, and player numbers for the purchased draw lottery ticket; and
the second plurality of instructions stored on the server memory device, when executed by the server processor, cause the server processor to compare the bet details and the ticket details to validate the lottery ticket order.

8. The lottery ticket selling system of claim 7, wherein the ticket purchase identifier is independent from the ticket details.

9. The lottery ticket selling system of claim 1, wherein the lottery ticket selling system further comprises a lottery ticket scanner that scans the printed draw lottery ticket to create ticket image data and sends the ticket image data to the electronic ticket retail server, the ticket image data comprising the ticket purchase identifier.

10. The lottery ticket selling system of claim 1, wherein the first plurality of instructions stored on the terminal memory device, when executed by the terminal processor, cause the terminal processor to:
generate a bet request based on the scanned bet slip data, the bet request comprising the ticket purchase identifier;
send the bet request to a lottery central system to cause the purchase of the draw lottery ticket; and
receive a bet response from the lottery central system, the bet response comprising the ticket details and the ticket purchase identifier.

11. The lottery ticket selling system of claim 10, wherein the first plurality of instructions stored on the terminal memory device, when executed by the terminal processor, cause the terminal processor to store recent scanned bet slip data for a plurality of digital bet slips and prevent generation of the bet request upon a determination that the scanned bet slip data matches the recent scanned bet slip data.

12. A lottery ticket selling system comprising:
an electronic bet details display device comprising a display device and a ticket code reader;
a lottery terminal associated with a terminal code reader and a lottery ticket printer, the lottery terminal comprising a terminal processor and a terminal memory device that stores a first plurality of instructions; and
an electronic ticket retail server comprising a server processor and a server memory device that stores a second plurality of instructions, which when executed by the server processor, cause the server processor to:
receive an order comprising bet details for a purchase of a draw lottery ticket for an original purchaser;
generate a ticket purchase identifier for the draw lottery ticket prior to the purchase of the draw lottery ticket, wherein the original purchaser is uniquely identifiable using the ticket purchase identifier;
generate a digital bet slip that comprises the bet details for the draw lottery ticket and the ticket purchase identifier; and
send the digital bet slip to the electronic bet details display device such that the electronic bet details display device receives and displays the digital bet slip via the display device;
wherein the first plurality of instructions stored on the terminal memory device, when executed by the terminal processor, cause the terminal processor to:
employ the terminal code reader to scan the displayed digital bet slip to obtain scanned bet slip data;
cause the purchase of the draw lottery ticket based on the scanned bet slip data; and
cause the lottery ticket printer to print the purchased draw lottery ticket, the printed draw lottery ticket comprising ticket details and the ticket purchase identifier; and
wherein the electronic bet details display device employs the ticket code reader to scan the printed draw lottery ticket to obtain scanned draw lottery ticket data and sends the scanned draw lottery ticket data to the electronic ticket retail server.

13. The lottery ticket selling system of claim 12, wherein the scanned draw lottery ticket data comprises the ticket purchase identifier.

14. The lottery ticket selling system of claim 12, wherein:
the printed draw lottery ticket comprises a substrate with a draw ticket QR code printed thereon; and
the draw ticket QR code comprises the ticket purchase identifier.

15. The lottery ticket selling system of claim 14, wherein the draw ticket QR code comprises the ticket details.

16. A lottery ticket selling system comprising:
a lottery central system comprising a central system processor and a central system memory device that stores a first plurality of instructions; and
a lottery terminal associated with a code reader and a lottery ticket printer, the lottery terminal comprising a terminal processor and a terminal memory device that stores a second plurality of instructions, which when executed by the terminal processor, cause the terminal processor to:
employ the code reader to scan a bet slip to obtain scanned bet slip data, the bet slip comprising bet details for a purchase of a draw lottery ticket and a ticket purchase identifier for the draw lottery ticket, wherein an original purchaser of the draw lottery ticket is uniquely identifiable using the ticket purchase identifier;
generate a bet request based on the scanned bet slip data, the bet request comprising the ticket purchase identifier and the bet details; and
send the bet request to the lottery central system to cause the purchase of the draw lottery ticket;
wherein the first plurality of instructions stored on the central system memory device, when executed by the central system processor, cause the central system processor to:
receive the bet request from the lottery terminal;
generate a bet comprising ticket details for a purchased draw lottery ticket based on the bet request;
log the bet and the ticket purchase identifier for the purchased draw lottery ticket;
generate a bet response comprising the ticket details and the ticket purchase identifier; and
send the bet response to the lottery terminal; and
wherein the second plurality of instructions stored on the terminal memory device, when executed by the terminal processor, cause the terminal processor to:
receive the bet response from the lottery central system; and
cause the lottery ticket printer to print the purchased draw lottery ticket, the printed draw lottery ticket comprising the ticket purchase identifier and the ticket details.

17. The lottery ticket selling system of claim 16, wherein the ticket purchase identifier comprises an original purchaser identifier employable to associate the purchased draw lottery ticket with the original purchaser.

18. The lottery ticket selling system of claim 17, wherein:
the original purchaser identifier comprises an original purchaser digital signature that does not by itself uniquely identify the original purchaser; and
the original purchaser digital signature is employable with a cryptographic function to uniquely identify the original purchaser.

19. The lottery ticket selling system of claim 16, wherein the first plurality of instructions stored on the central system memory device, when executed by the central system processor, cause the central system processor to generate the bet independently from the ticket purchase identifier.

20. The lottery ticket selling system of claim 16, wherein:
the bet details comprise a draw game identifier that identifies a lottery game type, a draw date, and player numbers for the purchase of the draw lottery ticket; and
the ticket details comprise a draw game identifier for the purchased draw lottery ticket, a draw date for the purchased draw lottery ticket, and player numbers for the purchased draw lottery ticket.
